(19) United States
(12) Patent Application Publication
(10) Pub. No.: US 2026/0110806 A1
(43) Pub. Date: Apr. 23, 2026

(54) POSITIONING SYSTEM PROVIDING SEAMLESS GEODETIC COORDINATES BOTH INSIDE AND OUTSIDE BUILDINGS WITH ERROR PROPAGATION

(71) Applicant: Jason Sean O'Flanagan, Austin, TX (US)

(72) Inventors: Jason Sean OFlanagan, Austin, TX (US); Frederick Theodore Nugen, Rochester, MN (US)

(21) Appl. No.: 19/359,914

(22) Filed: Oct. 16, 2025

Related U.S. Application Data
(60) Provisional application No. 63/709,557, filed on Oct. 21, 2024.

(51) Int. Cl. G01S 19/48

(52) U.S. Cl. CPC G01S 19/48

(57) ABSTRACT

This invention presents an integrated system for continuous geodetic positioning in both indoor and outdoor environments. It combines Global Navigation Satellite System (GNSS) technology with indoor positioning methods using Bluetooth Low Energy Angle of Arrival (BLE-AoA) and Ultra-Wideband (UWB) transponders. The system outputs data in GNSS format for compatibility with existing applications. It utilizes GNSS for outdoor positioning and facilitates seamless transitions between environments by calibrating the indoor systems near building openings from GNSS data. For areas where GNSS is unreliable or unavailable, it relies solely on indoor positioning technologies. In addition to the building scenario emphasized in this application, the system works also in mines, tree farms, and dense forests. The system features real-time updates of transponder data to maintain and continuously compute location accuracy, thereby addressing limitations of traditional GNSS-only systems while ensuring positioning continuity across diverse settings.

### TECHNICAL FIELD

Global Navigation Satellite Systems (GNSS) are used to determine the position, velocity, and time of a receiver on the Earth. GNSS antennas are used to receive the signals from GNSS satellites. There are many different types of GNSS antennas available, each with its own advantages and disadvantages.

The Wide Area Augmentation System (WAAS) is a satellite-based augmentation system (SBAS) that provides improved accuracy, integrity, and availability to GNSS users in North America. WAAS uses a network of ground stations to monitor the GPS signal and transmit corrections to GPS receivers. These corrections can be used to improve the accuracy of GPS position estimates by up to a factor of 10. WAAS also provides integrity information to GPS receivers, which helps to ensure that the GPS signal is reliable and can be trusted for safety-critical applications. There are other SBAS systems in operation around the world, including European Geostationary Navigation Overlay Service (EGNOS), Multi-functional Satellite Augmentation System (MSAS), and Quasi-Zenith Satellite System (QZSS).

Ultra-Wideband (UWB) according to IEEE standard 802.15.4a is a wireless communication technology standard that offers several key advantages in short-range, high-precision applications. This technology is characterized by its ability to determine the relative position of devices with centimeter-level accuracy, making it ideal for indoor positioning and navigation systems. UWB is designed to be energy-efficient, consuming low power which makes it particularly suitable for battery-powered devices in the Internet of Things (IoT) ecosystem.

One of the standout features of UWB is its capacity to support high data rates, potentially reaching several hundred megabits per second over short distances. This capability, combined with its robust performance in challenging environments, sets it apart from many other wireless technologies. UWB is less susceptible to multipath fading and interference compared to narrowband technologies, allowing for more reliable communication in complex indoor settings.

Typically operating within a range of about 10 meters, UWB excels in short-range communication scenarios. It incorporates built-in security features to protect against eavesdropping and spoofing, making it a secure choice for sensitive applications such as access control systems. The technology has found significant use in various fields, including asset tracking, automotive applications like keyless entry systems, and general IoT device communication.

The underlying principle of UWB technology involves the use of very short, low-power pulses spread over a wide spectrum of frequencies. This approach allows UWB to coexist with other wireless technologies without causing significant interference, further enhancing its versatility and applicability in diverse environments.

Bluetooth Low Energy Angle of Arrival (BLE-AoA) estimation is a feature introduced in Bluetooth 5.1 that enables precise indoor positioning and direction finding. This technology allows devices to determine the direction from which a Bluetooth signal is coming, opening up new possibilities for location-based services and applications.

The BLE-AoA technique works by utilizing an array of antennas on the receiving device. When a transmitting device sends a special type of signal called a Constant Tone Extension (CTE), the receiving device samples the phase differences of this signal across its multiple antennas. By analyzing these phase differences, the receiver can calculate the angle at which the signal arrived.

This process requires precise timing and synchronization between the transmitter and receiver. The transmitting device sends out a packet with the CTE, which is essentially a constant frequency signal. The receiving device, equipped with an antenna array, rapidly switches between its antennas to sample the signal at different physical locations. The phase differences observed across these samples are then used to compute the angle of arrival.

BLE-AoA can achieve angular accuracy within a few degrees, depending on factors such as the number of antennas, the quality of the radio hardware, and environmental conditions. This level of accuracy makes it suitable for various applications, including asset tracking in warehouses, indoor navigation in large buildings, and even finding lost items equipped with Bluetooth tags.

One of the key advantages of using BLE-AoA is its low energy consumption, making it suitable for battery-powered devices that need to operate for extended periods. Additionally, as it's built on the widely adopted Bluetooth standard, it can be integrated into many existing devices through software updates, provided they have the necessary hardware capabilities.

Like most physical measurements, measurements from UWB have a certain inherent error which defines the precision of the measured value. Physical measurement error can be estimated in a variety of ways. For instance, it can be calculated as a real-time estimate, or it can be averaged from multiple measurements. Real-time levels of precision of measurements is an important consideration for positioning systems [Kaplan, E.D., & Hegarty, C.J. (2017). Understanding GPS/GNSS: Principles and Applications. Artech House].

### BACKGROUND

GNSS systems, while highly effective for outdoor positioning, become notoriously unreliable inside buildings. This limitation stems from the fundamental nature of satellite-based positioning. GNSS signals, transmitted from satellites orbiting the Earth, are significantly weakened and distorted as they pass through building materials such as concrete, steel, and glass. These structures attenuate, reflect, and refract the signals, leading to multipath effects and signal loss. Consequently, indoor environments often suffer from poor satellite visibility, weak signal strength, and erroneous position calculations. The problem is exacerbated in multi-story buildings, underground spaces, and areas surrounded by tall or overhanging structures, where signal penetration is even more limited. This inherent weakness of GNSS in indoor settings has spurred the development of alternative indoor positioning technologies and hybrid systems that aim to provide seamless positioning across both indoor and outdoor environments.

The need for seamless geodetic coordinates that function both inside and outside of buildings has become increasingly apparent. This technology is particularly sought after by autonomy companies aiming to achieve uninterrupted indoor and outdoor navigation capabilities. Additionally, it has practical applications in industries such as dairy farming, where precise recording of feed locations is crucial for traceability purposes. These current options often come with significant drawbacks, including high costs and complex setup requirements. This situation highlights a gap in the market for a more versatile, cost-effective, and user-friendly solution that can provide continuous positioning across both indoor and outdoor spaces.

GNSS signal reliability faces significant challenges in various environments. In low-horizon satellite regions, such as areas north of the Arctic Circle, GNSS signals are weakened due to the low angle of satellite transmissions. These signals become more susceptible to atmospheric interference and obstruction.

Urban and built environments present their own set of challenges. GNSS performance can degrade deep within buildings, near building entrances, or even in outdoor areas with obstructions such as trees, awnings, and adjacent structures. Natural obstructions like dense tree foliage can impair GNSS performance even in seemingly open outdoor settings.

Underground environments, such as mines, pose particular difficulties where traditional geodetic or terrestrial solutions are ineffective, and GNSS signals may be completely unavailable.

In these challenging scenarios, alternative technologies can augment or replace GNSS. For instance, Ultra-Wideband (UWB) technology offers a viable solution in mines and other environments where GNSS performance is suboptimal. UWB can provide accurate positioning both underground and in above-ground areas with heavy foliage or other obstructions.

This approach of combining GNSS with complementary technologies ensures more consistent and reliable positioning across a diverse range of challenging environments, from urban canyons to dense forests and subterranean spaces.

Conventional UWB positioning systems operate by strategically placing anchors around a designated area, all interconnected via a local network. These anchors communicate distance data to a central server, which then processes this information to calculate the precise X-Y coordinates of devices within the establishment. To visualize the device locations, a web server is typically required. While this technology has proven its effectiveness, it comes with several notable drawbacks.

The installation, calibration, and setup processes of UWB positioning systems are often expensive and need to be tailored to each specific location. Moreover, these systems demand constant maintenance to maintain their accuracy. Another limitation is that the location information generated is confined to the particular building where the system is installed. Additionally, these conventional systems only provide information about a device's location, not its orientation. The reliance on a server and web host for system functionality adds another layer of complexity and potential points of failure. Despite these challenges, the proven accuracy of UWB positioning continues to make it a viable option for many applications requiring precise indoor localization.

BLE-AoA technology operates on a principle that involves strategically positioned anchor nodes throughout an area. These anchor nodes are designed to measure the location of a Bluetooth-enabled client device by analyzing the angle at which the device's signals arrive at each anchor. This data is then transmitted to a centralized processor or computer, which uses complex algorithms to calculate the precise position of the client device.

The BLE-AoA system's functionality hinges on a robust network infrastructure that facilitates the seamless transfer of data from the anchors to the central processing unit. Once the position is determined, this information can be distributed to various services that require location data. However, implementing such a system comes with significant financial implications. The primary expenses are associated with the specialized hardware required for the anchor nodes and the need for professional installation and configuration of the network infrastructure. This combination of sophisticated technology and professional setup contributes to the overall cost and complexity of BLE-AoA positioning systems.

GNSS technology has seen widespread adoption, leading to heightened demands for positional accuracy. For instance, cell phone companies now face stringent requirements to pinpoint phone locations with room-level precision within buildings. Furthermore, the ability to measure and estimate accuracy has become crucial for systems relying on location data. As GNSS device technology progresses, it enables the creation of increasingly precise and accurate positional data. Modern devices are better equipped to meet these growing demands for accuracy. However, it's important to note that achieving greater precision in position estimates comes at a cost, often requiring more complex systems and increased financial investment.

### BRIEF SUMMARY

The present invention provides a system and method for seamless geodetic positioning across indoor and outdoor environments and for estimating position errors. This innovation integrates Global Navigation Satellite System (GNSS) technology with indoor positioning technologies that utilize transponders at known locations. In one implementation, the indoor positioning technologies comprise Bluetooth Low Energy Angle of Arrival (BLE-AoA) and Ultra-Wideband (UWB) positioning systems. The invention may output positioning data in GNSS format, ensuring compatibility with existing GNSS-based applications.

The system incorporates a comprehensive database of transponder locations within the building of interest. For outdoor locations, the system relies on GNSS technology for positioning. In areas near building openings, GNSS positioning facilitates the system's on-the-fly calibration of the indoor positioning technologies, ensuring a smooth transition between outdoor and indoor environments. For locations where GNSS signals are unavailable or unreliable, the system exclusively utilizes indoor positioning technologies to determine location. A key feature of the invention is its ability to continuously update and adjust transponder data in real-time, accounting for environmental changes and potential movement of transponders. This updated information, which includes position error estimates, is periodically transmitted to a server, ensuring all system components operate with the most current data. This integrated approach enables seamless and accurate positioning across diverse environments, addressing the limitations of traditional GNSS-only systems in indoor spaces while maintaining continuity with outdoor positioning. The versatility of this system extends well beyond building scenarios to include applications involving mining, tree farms, and dense forests.

### BRIEF DESCRIPTION OF THE DRAWINGS

For a more complete understanding of the present disclosure, reference is now made to the following descriptions taken in conjunction with the accompanying drawings.

FIG. 1 is a schematic illustrating how the Beacon system operates by receiving both BLE-AoA information and UWB distance data from multiple transponders. Utilizing an internal database containing transponder location information, the beacon processes this data to generate its precise latitude and longitude coordinates within buildings. In addition, the Beacon is hooked up to a GNSS receiver.

FIG. 2 is a schematic illustrating the Beacon hooked up to a GNSS receiver and any End User Device downstream that reads standard GNSS data. When the beacon is inside the building, data will appear to come from a GNSS receiver but it is actually calculated by the Beacon and provided to the End User Device in the standard GNSS format. When the GNSS solution is re-established upon leaving the building, the system will change over seamlessly to the GNSS solution without any jumps or loss of position.

FIG. 3 presents a schematic depiction of a Beacon's trajectory as it moves in a linear path, beginning outside a building, traversing through the building, and ultimately emerging on the opposite side. This illustration demonstrates the seamless transition between different positioning technologies employed by the Beacon to maintain accurate location data throughout its journey. The Beacon's position is determined through a combination of methods: initially utilizing a standard GNSS solution while outdoors, transitioning to a Sensor Fusion Solution as it approaches and enters the building, relying on a BLE-AoA solution and a UWB solution while inside, and finally reverting to the standard GNSS solution upon exiting. Notably, the Sensor Fusion Solution incorporates data from both the standard GNSS and the BLE-AoA and UWB systems, ensuring a smooth and accurate transition between outdoor and indoor environments.

FIG. 4 presents a schematic depiction of a Beacon's trajectory as it moves through a U-turn path, beginning outside a building, traversing into the structure, and ultimately emerging outside on the same side of the building.

FIG. 5 presents a schematic depiction of a Beacon's trajectory as it moves through an unstructured path, beginning outside a building, traversing into the structure, and ultimately emerging outside of the building.

FIG. 6 illustrates the Transponder Calibration Procedure, showcasing the system's adaptability and self-calibrating capabilities. The schematic depicts how transponders can be placed in an ad-hoc manner along the Beacon's travel path, eliminating the need for precise pre-positioning. The calibration process begins by utilizing the GNSS solution to accurately determine the initial Beacon locations outside the building. As the Beacon moves through the building, it progressively calibrates the remaining transponders, creating a comprehensive indoor positioning network.

### DETAILED DESCRIPTION OF THE DRAWINGS

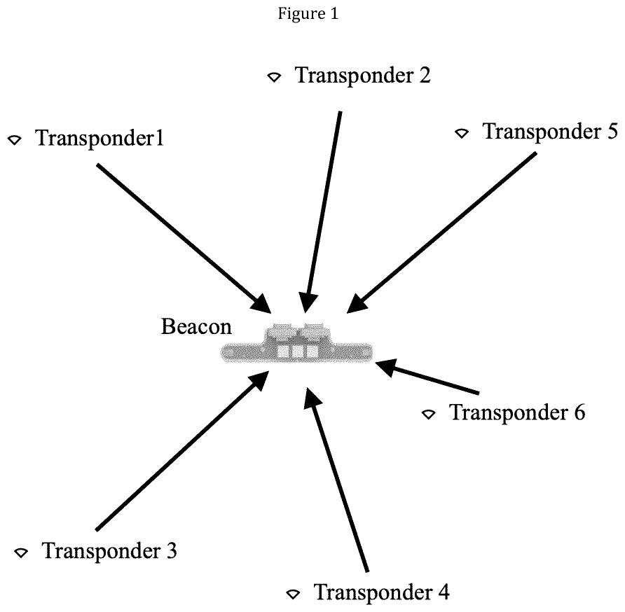

FIG. 1 is a schematic illustrating how the Beacon system operates by receiving both BLE-AoA information and UWB distance data from multiple transponders. The Beacon comprises a database storing comprehensive information about transponder locations. This database, in conjunction with the received BLE-AoA and UWB data, enables the Beacon to generate precise latitude and longitude coordinates within enclosed structures. The dual utilization of UWB and BLE-AoA technologies facilitates improved performance and allows for real-time calibration, resulting in enhanced course-over-ground accuracy. This precision is instrumental in supporting an advanced dead reckoning sensor fusion solution implemented within the system.

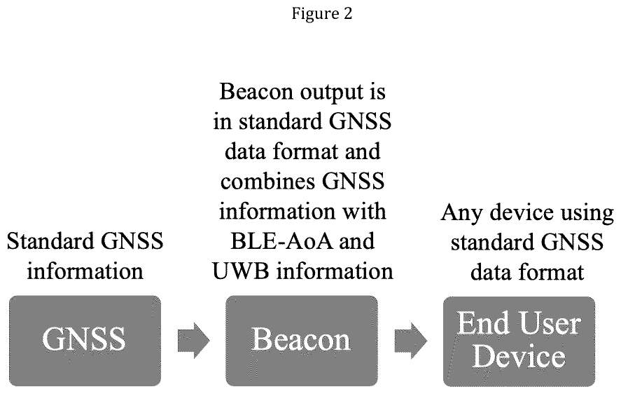

FIG. 2 is a schematic illustrating the Beacon hooked up to a GNSS receiver and any End User Device downstream that reads standard GNSS data. When the Beacon is inside the building, data will appear to come from the GNSS receiver but it is actually calculated by the Beacon and provided to the End User Device in the standard GNSS data format. When the GNSS solution is re-established upon leaving the building, the system will change over seamlessly to the GNSS solution without any jumps or loss of position.

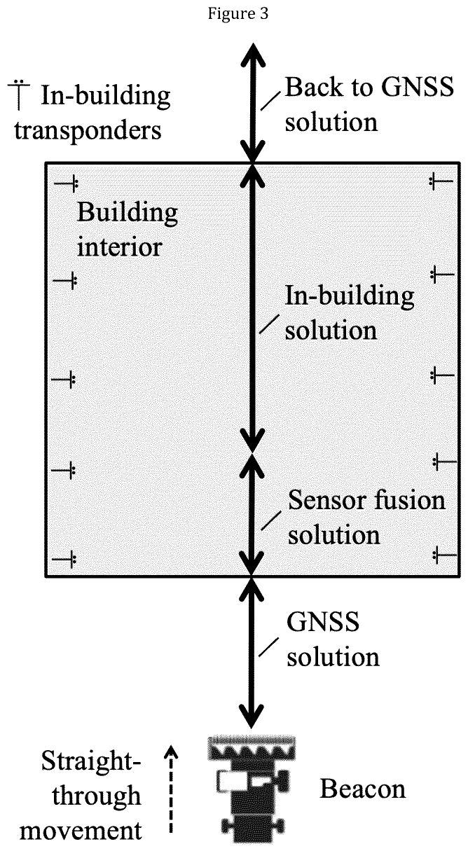

FIG. 3 presents a schematic depiction of a Beacon's trajectory as it moves in a linear path, beginning outside a building, traversing through the structure, and ultimately emerging on the opposite side. This illustration demonstrates the seamless transition between different positioning technologies employed by the Beacon to maintain accurate location data throughout its journey. The Beacon's position is determined through a combination of methods: initially utilizing a standard GNSS solution while outdoors, transitioning to a Sensor Fusion Solution as it approaches and enters the building, relying on a BLE-AoA solution and a UWB solution while inside, and finally reverting to the standard GNSS solution upon exiting. Notably, the Sensor Fusion Solution incorporates data from both the standard GNSS and the BLE-AoA and UWB systems, ensuring a smooth and accurate transition between outdoor and indoor environments.

The invention's architecture allows for flexible deployment in various environments, with transponders placed in an ad-hoc manner around anticipated Beacon travel paths. Initial calibration can be performed using GNSS solutions for outdoor positions, with subsequent indoor calibration occurring as the Beacon traverses the building.

A key aspect of the invention is its adaptive nature. The system continuously updates and adjusts transponder data to compensate for environmental changes, such as movement or obstructions in the vicinity of the transponders and change in atmospheric conditions. This updated information is periodically transmitted to a central server, ensuring all Beacon devices within a facility operate with current, accurate positioning data.

The invention offers several advantageous features: (i) Rapid deployment through self-calibrating transponders and continuous fine-tuning capabilities. (ii) Cost-effective implementation with low per-site expenses. (iii) Seamless scalability, allowing easy integration of additional vehicles or buildings. (iv) Decentralized intelligence at the vehicle level, eliminating the need for complex networking infrastructure. (v) Scalable accuracy through the addition of transponders. (vi) Compatibility with SL Lite-R receivers, enabling uninterrupted positioning across indoor and outdoor environments.

In one implementation, the system is configured to transmit updated transponder data to the central server at predetermined intervals, such as every 15 minutes. This allows for more robust processing and ensures all Beacon devices within the network maintain synchronization and operate with the most current positioning information.

This system represents a significant advancement in location technologies, offering a versatile, scalable, and cost-effective solution for seamless geodetic positioning across diverse environments. Its ability to provide continuous, accurate positioning data both indoors and outdoors addresses a long-standing challenge in the field of location-based services and applications.

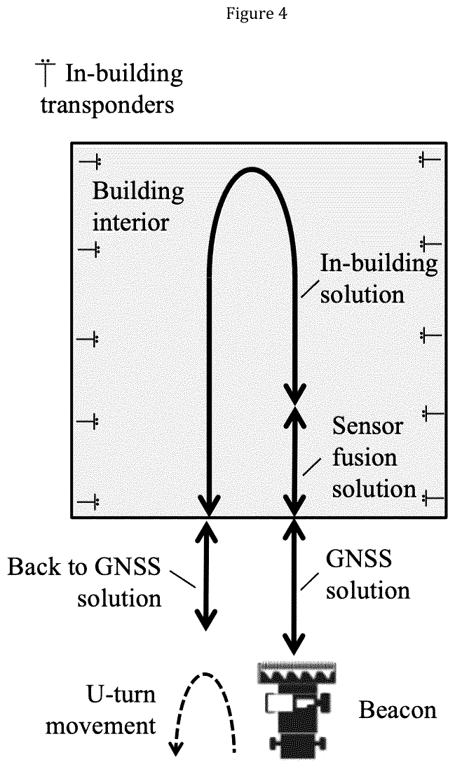

FIG. 4 presents a schematic depiction of a Beacon's trajectory as it moves through a U-turn path, beginning outside a building, traversing into the structure, and ultimately emerging outside on the same side of the building. The same approach described above provides the seamless transition between different positioning technologies employed by the Beacon to maintain accurate location data throughout its journey.

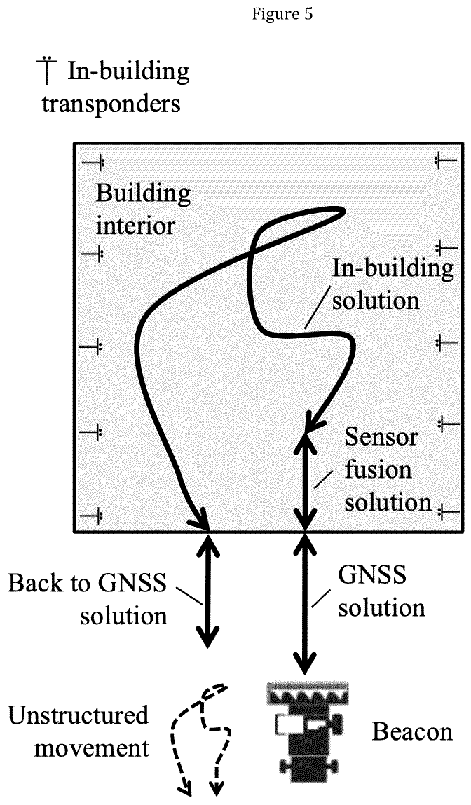

FIG. 5 presents a schematic depiction of a Beacon's trajectory as it moves through an unstructured path, beginning outside a building, traversing into the structure, and ultimately emerging outside of the building. The same approach described above provides the seamless transition between different positioning technologies employed by the Beacon to maintain accurate location data throughout its journey.

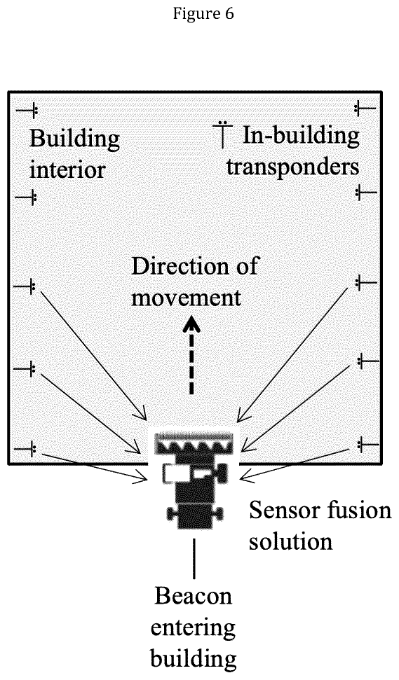

FIG. 6 illustrates the Transponder Calibration Procedure, showcasing the system's adaptability and self-calibrating capabilities. The schematic depicts how transponders can be placed in an ad-hoc manner along the Beacon's travel path, eliminating the need for precise pre-positioning. The calibration process begins by utilizing the GNSS solution to accurately determine the initial Beacon locations outside the building. As the Beacon moves through the building, it progressively calibrates the remaining transponders, creating a comprehensive indoor positioning network. The region where the Beacon is near the building opening is called the transitional environment. During the initial setup phase, the system enters a calibration mode, performing multiple passes through the building to refine its accuracy. This calibration process continues until the desired level of precision from the transponders is achieved. Following this initial phase, the system transitions into a continual improvement mode, where it regularly updates and stores the transponder locations on a central server. This approach allows for the sharing of calibration data across multiple machines, ensuring consistent and accurate positioning throughout the entire facility.

This approach allows faulty or missing transponders to be disregarded and new ones to be included. Specifically, the system will seamlessly work around faulty or missing transponders and new transponders will be initialized with calibrated data from existing transponders.

The position calculation goes as follows. Assume first that we want to compute the location in rectangular coordinates (x, y, z) of the Beacon from knowledge of the locations (xᵢ, yᵢ, zᵢ) of the transponders and the distances dᵢ between each transponder and the Beacon. The resulting set of equations can be solved using the method of least squares, which is cast in the form of a matrix equation where (x, y, z) are the unknowns. In practice, (xᵢ, yᵢ, zᵢ) and dᵢ are known only to within a certain error level. Therefore, both the matrix and the righthand side of the least-squares equation contain errors, so the least-squares solution (x, y, z) will also contain errors.

We can estimate the errors of (x, y, z) by solving the least-squares problem multiple times using parameter values for (xᵢ, yᵢ, zᵢ) and dᵢ that span the error interval for each parameter. For example, if the error estimate for xᵢ is eᵢ, we would solve the least-squares problem with xᵢ set equal to xᵢ−eᵢ and xᵢ+eᵢ. We thereby obtain an error interval for (x, y, z) that depends on the error interval for (xᵢ, yᵢ, zᵢ) and dᵢ. The errors of the known parameters thus results in errors in the computed parameters. This phenomenon is known as error propagation. This same approach to computing location errors is used during the calibration process where the transponder locations are the unknowns. The error interval can alternatively be obtained by using the tangent-plane approximation or a number of other well-known methods.

The versatility of this system extends well beyond its primary application in building scenarios. Its functionality is equally effective in a variety of challenging environments:

Mines: In underground mining operations, where traditional GNSS signals are often unreliable or nonexistent, this system provides crucial positioning data.

Tree farms: In large-scale forestry operations, the system offers precise location services that aid in inventory management, growth monitoring, and harvest planning.

Dense forests: Natural forests present unique challenges for positioning systems due to heavy canopy cover that can interfere with satellite signals.

The detailed description provided herein presents specific embodiments of the invention for illustrative purposes. However, it should be understood that these specific examples are not intended to limit the scope of the invention. A person of ordinary skill in the art, upon reviewing this disclosure, will recognize that the principles, methods, and systems described can be readily adapted and applied to produce various alternative implementations. Therefore, the scope of the invention should not be construed as confined to the specific embodiments detailed, but rather encompasses the full range of equivalent implementations that would be apparent to one skilled in the art based on the teachings provided herein.

What is claimed is:

1. A system for seamless geodetic positioning across indoor, outdoor, and transitional environments, comprising:
(a) a Global Navigation Satellite System (GNSS) module for outdoor positioning;
(b) at least one indoor positioning module utilizing transponders at known or unknown locations;
(c) a database storing transponder locations;
(d) a processor configured to:
(i) use GNSS for outdoor positioning;
(ii) calibrate indoor positioning using GNSS where GNSS may have reduced accuracy;
(iii) use indoor positioning technologies for locations deep within the building or anywhere GNSS is unavailable or unreliable;
(iv) continuously update and adjust transponder data in real-time;
(v) continuously update and adjust location error estimates;
(e) a communication module to periodically transmit updated transponder data to a server.

2. The system of claim 1, wherein the indoor positioning module comprises Bluetooth Low Energy Angle of Arrival (BLE-AoA) and Ultra-Wideband (UWB) positioning systems.

3. The system of claim 1, wherein the processor is further configured to output positioning data in GNSS format.

4. A method for seamless geodetic positioning across indoor and outdoor environments, comprising:
(a) utilizing GNSS technology for outdoor positioning;
(b) employing indoor positioning technologies using transponders at known or unknown locations for indoor positioning;
(c) calibrating indoor positioning technologies using GNSS positioning where GNSS may have reduced accuracy;
(d) switching to exclusive use of indoor positioning technologies for locations deep within a building;
(e) continuously updating and adjusting transponder data in real-time;
(f) periodically transmitting updated transponder data to a server.

5. The method of claim 4, further comprising outputting positioning data in GNSS format.

6. The method of claim 4, wherein the indoor positioning technologies comprise BLE-AoA and UWB positioning systems.

7. The system of claim 1, wherein the processor is further configured to account for environmental changes and potential movement of transponders when updating transponder data.

8. The method of claim 4, further comprising maintaining a comprehensive database of transponder locations within the building.

9. The system of claim 1, wherein the processor is further configured to ensure a smooth transition between outdoor and indoor environments by calibrating indoor positioning technologies near building openings.
